(19) United States
(12) Patent Application Publication
(10) Pub. No.: US 2007/0195751 A1
(43) Pub. Date: Aug. 23, 2007

(54) Providing voicemail blocking in communication networks

(75) Inventors: Yigang Cai, Naperville, IL (US); Shiyan Hua, Lisle, IL (US)

Correspondence Address: DUFT BORNSEN & FISHMAN, LLP, 1526 SPRUCE STREET, SUITE 302, BOULDER, CO, 80302, US

(73) Assignee: Lucent Technologies Inc.

(21) Appl. No.: 11/358,552

(22) Filed: Feb. 21, 2006

(51) Int. Cl. H04L 12/66

(52) U.S. Cl. 370/352

(57) ABSTRACT

Communication networks and associated methods are disclosed that provide a voicemail blocking service. A communication network of the invention comprises a network node and a voicemail system. The network node receives a call from a calling party to a subscriber of the voicemail blocking service, and attempts to connect the call to a communication device of the subscriber. If the subscriber does not answer the call, then the network node processes voicemail blocking information for the subscriber to determine whether the call is allowed to be routed to the voicemail system. If a determination is made that the call is not allowed to be routed to the voicemail system, then the network node blocks the call from being routed to the voicemail system. If a determination is made that the call is allowed to be routed to the voicemail system, then the network node routes the call to the voicemail system.

### BACKGROUND OF THE INVENTION

1. Field of the Invention

The invention is related to the field of communication networks and, in particular, to a voicemail blocking service in communication networks.

2. Statement of the Problem

Most service providers offer voicemail services in communication networks. As an example of voicemail services in a wireless network, a calling party places a call to a called party through the wireless network. A Mobile Switching Center (MSC) serving the calling party receives the call and routes the call to an MSC serving the called party. Responsive to receiving the call, the MSC serving the called party provides alerting to the called party in an attempt to connect the call to the called party. If the called party does not answer the call, then the MSC routes the call to a voicemail server in the wireless network (assuming the called party has subscribed to the voicemail service). The calling party may then leave a voicemail message for the called party in the voicemail server that can later be retrieved by the called party.

Voicemail messages may also be broadcast to a plurality of parties. To generate a broadcast voicemail message, the sender records the voicemail message and enters a plurality of numbers for the recipients of the broadcast voicemail message. The sender then transmits the voicemail message to the communication network. When the broadcast voicemail message is received in the communication network, the receiving network node (e.g., a switch, MSC, etc) identifies that the message is a broadcast voicemail message, and routes the message to the appropriate voicemail server(s) of the recipients. Broadcast voicemail messages can be used in a variety of situations, such as by mass marketing entities to transmit marketing-type voicemail messages. These marketing-type voicemail messages may comprise unwanted spam to some recipients.

One problem with present voicemail services is that unwanted voicemail messages may be received. There may be calling parties from which a voicemail subscriber does not wish to receive voicemail messages. One example of unwanted voicemail messages is the broadcast voicemail messages that may be considered spam, but there may also be individual senders from which a voicemail subscriber does not wish to receive voicemail messages.

Presently, some service providers offer a selective call blocking service that allows a subscriber to define one or more calling parties that are prevented from calling the subscriber. If one of the defined calling parties places a call to the subscriber, the network blocks the call from being connected to the subscriber. By blocking the call, the calling parties also cannot leave a voicemail message. Thus, the selective call blocking service inherently blocks these defined calling parties from leaving voicemail messages.

Unfortunately, the selective call blocking service blocks both calls and voicemail messages. There may instances where the subscriber wants to be able to receive calls from certain calling parties, but does not want these calling parties to leave voicemail messages. Present communication networks do not provide this option its subscribers.

### SUMMARY OF THE SOLUTION

The invention solves the above and other problems by providing a voicemail blocking service in communication networks. The voicemail blocking service allows a subscriber, a service provider, and/or another party to define voicemail blocking information that acts as filtering criteria for determining when a calling party is allowed to leave a voicemail message for a subscriber. A subscriber to the voicemail blocking service can advantageously block voicemail messages from certain individual calling parties or may block broadcast voicemail messages so as to filter spam-type voicemail messages or other unwanted voicemail messages.

In one embodiment of the invention, a communication network for providing the voicemail blocking service comprises a network node and a voicemail system. To provide the voicemail blocking service, the network node receives a call from a calling party that is directed to a subscriber of the voicemail blocking service. Responsive to receiving the call, the network node attempts to connect the call to a communication device of the subscriber. If the subscriber does not answer the call, then the network node processes voicemail blocking information for the subscriber to determine whether the call is allowed to be routed to the voicemail system. The voicemail blocking information is predefined by the subscriber, a service provider operating the communication network, and/or another party. The voicemail blocking information may be stored in the network node, may be stored in a subscriber database (e.g., an HLR or an HSS), or may be stored in another system in the communication network.

If a determination is made that the call is not allowed to be routed to the voicemail system, then the network node blocks the call from being routed to the voicemail system. The network node may then release the call. If a determination is made that the call is allowed to be routed to the voicemail system, then the network node routes the call to the voicemail system. The calling party may then leave a voicemail message for the subscriber.

The voicemail blocking information may include a white-list of calling parties allowed to leave voicemail messages. The voicemail blocking information may additionally or alternatively include a black-list of calling parties that are not allowed to leave voicemail messages. The white-list and the black-list may be generated by the subscriber, the service provider of the communication network, and/or another party.

The voicemail blocking service is different than the selective call blocking service presently offered in that the communication network attempts to connect the call to the subscriber before performing the voicemail blocking. After the attempt to connect the call has failed, the network node processes the voicemail blocking information to determine whether the calling party is allowed to leave a voicemail message. The voicemail blocking service advantageously allows the subscriber to control voicemail blocking separate from call blocking.

In another embodiment of the invention, the communication network provides a voicemail blocking service for blocking broadcast voicemail messages. To provide the service, the network node receives a broadcast voicemail message transmitted by calling party through a communication device. The network node processes voicemail blocking information to determine whether the broadcast voicemail message is allowed to be routed to the voicemail system for the recipients of, the broadcast voicemail message. If the network node determines that the broadcast voicemail message is not allowed to be routed to the voicemail system based on the voicemail blocking information, then the network node blocks the broadcast voicemail message from being routed to the voicemail system. If the network node determines that the call is allowed to be routed to the voicemail system based on the voicemail blocking information, then the network node routes the broadcast voicemail message to the voicemail system.

The invention may include other exemplary embodiments described below.

### DESCRIPTION OF THE DRAWINGS

The same reference number represents the same element on all drawings.

FIG. 1 illustrates an exemplary communication network in an exemplary embodiment of the invention.

FIG. 2 is a flow chart illustrating an exemplary method of operating a communication network to provide a voicemail blocking service in an exemplary embodiment of the invention.

FIG. 3 is a flow chart illustrating an exemplary method of processing voicemail blocking information in an exemplary embodiment of the invention.

FIGS. 4-5 illustrate an example of implementing the voicemail blocking service in a wireless network in an exemplary embodiment.

FIGS. 6-7 illustrate an example of implementing the voicemail blocking service in an IMS network in an exemplary embodiment.

FIG. 8 is a flow chart illustrating another exemplary method of operating a communication network to provide the voicemail blocking service in an exemplary embodiment of the invention.

### DETAILED DESCRIPTION OF THE INVENTION

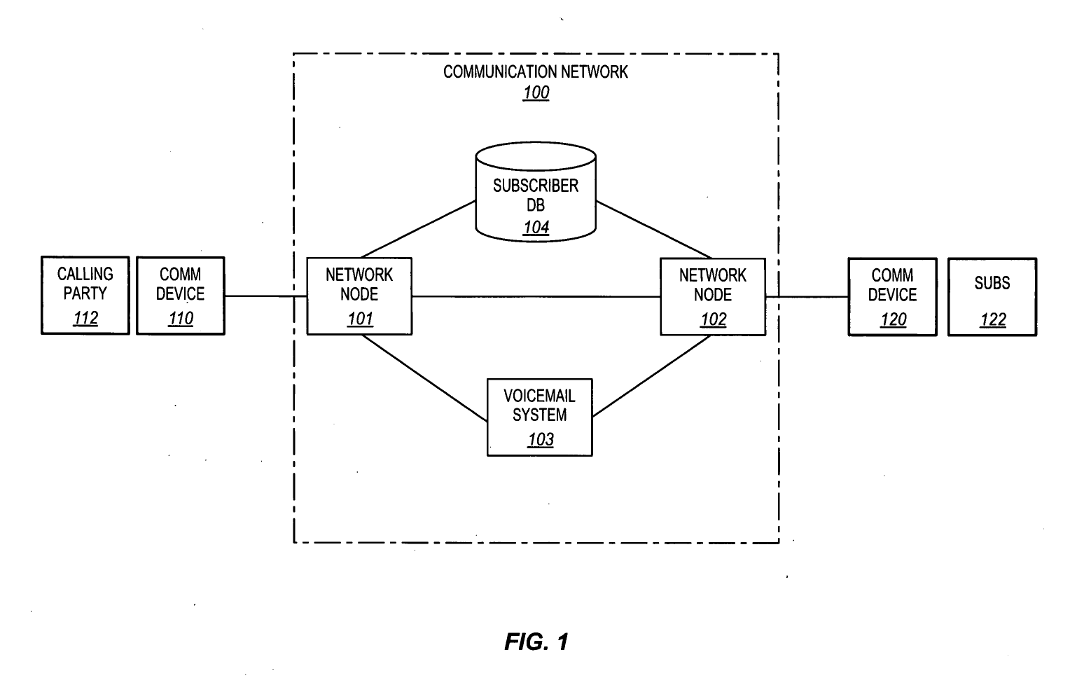

FIGS. 1-8 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an exemplary communication network 100 in an exemplary embodiment of the invention. Communication network 100 may comprise a wireline network, an IP Multimedia Subscriber (IMS) network, or a wireless network such as a Code Division Multiple Access (CDMA) network, a Time Division Multiple Access (TDMA) network, a Global System for Mobile Communication (GSM) network, or a Universal Mobile Telecommunications System (UMTS) network. Communication network 100 includes network nodes 101-102, a voicemail system 103, and a subscriber database 104. Communication network 100 may include other networks, systems, or devices not shown in FIG. 1.

Communication network 100 is adapted to provide a voicemail blocking service as will be described in more detail below. The voicemail blocking service in this embodiment is illustrated through a call from a calling party 112 to a subscriber 122 of the voicemail blocking service. Calling party 112 operates a communication device 110 to place calls to communication network 100. Subscriber 122 operates a communication device 120 to potentially receive calls from communication network 100. Communication devices 110 and 120 may each comprise a variety of communication devices, such as a wireline phone, a wireless (mobile) phone, a PDA, a PC, a VoIP phone, a SIP phone, etc.

Network nodes 101-102 include any switches, servers, or other devices that serve communication devices for communication. For instance, network nodes 101-102 may comprise switches in a wireline network, may comprise Mobile Switching Centers (MSC) in a wireless network, or may comprise Call Session Control Functions (CSCF) in an IMS network. In this embodiment, network node 101 serves the communication device 110 of calling party 112, and network node 102 serves the communication device 120 of subscriber 122. Those skilled in the art understand that communication devices 110 and 120 may be served by the same network node, but two network nodes 101-102 are shown merely for illustrative purposes.

Network nodes 101-102 may comprise instructions executable by a processing system to operate as described below to provide the voicemail blocking service. Some examples of instructions are software, program code, and firmware. The instructions are operational when executed by the processing system to direct the processing system to operate in accordance with the invention. The term “processing system” refers to a single processing device or a group of inter-operational processing devices. Some examples of processors are computers, integrated circuits, and logic circuitry.

Voicemail system 103 comprises any system, server, or application that handles voicemail services for subscriber 122. Calls in communication network 100 may be routed to voicemail system 103, and voicemail system 103 records and stores the voicemail messages for subscriber 122 and other subscribers (if allowed by the voicemail blocking service). Subscriber 122 may then access the voicemail messages in a conventional manner. Voicemail system 103 may comprise a voicemail server, such as in a wireless or wireline network. Voicemail system 103 may also comprise an Application Server (AS) in an IMS network.

Subscriber database 104 comprises any database or database system that stores subscriber information or subscriber profiles for subscribers of communication network 100. For instance, subscriber information may include information indicating where the subscriber is located, information as to what services the subscriber has subscribed to, etc. Subscriber database 104 may comprise a Home Location Register (HLR) in a wireless network. Subscriber database 104 may also comprise a Home Subscriber Server (HSS) in an IMS network.

To implement the voicemail blocking service, voicemail blocking information is established or defined for subscriber 122. The voicemail blocking information may be specified by subscriber 122, may be specified by the service provider operating communication network 100, or may be specified by other parties. As one example, the voicemail blocking information may include a white-list of calling parties approved to leave voicemail messages for subscriber 122. The white-list may include one or more directory numbers, one or more Public User IDs (PUID), a range of directory numbers, one or more network addresses, etc, of calling parties that are allowed to leave voicemail messages for subscriber 122. In another example, the voicemail blocking information may include a black-list of calling parties that are not approved to leave voicemail messages for subscriber 122. The black-list may again include one or more directory numbers, one or more PUIDs, a range of directory numbers, one or more network addresses, etc, of calling parties that are not allowed to leave voicemail messages for subscriber 122. The voicemail blocking information may include any other information used to filter voicemail messages for subscriber 122 according to the voicemail blocking service. The voicemail blocking information may be stored in subscriber database 104, may be stored in network nodes 101-102, or may be stored in another system or server not shown in FIG. 1.

To illustrate how the voicemail blocking service works, assume that calling party 112 places a call to subscriber 122 through communication device 110. Network node 101 receives the call and routes the call to network node 102 that is serving the communication device 120 of subscriber 122. Another assumption at this point is that network node 102 has the voicemail blocking information for subscriber 122 or can access the voicemail blocking information. As previously described, network node 102 may store the voicemail blocking information. Subscriber database 104 may also store the voicemail blocking information. If subscriber database 104 stores the voicemail blocking information, then network node 102 may request the voicemail blocking information from subscriber database 104, such as when communication device 120 registers with communication network 100 or at another time desired by network node 104.

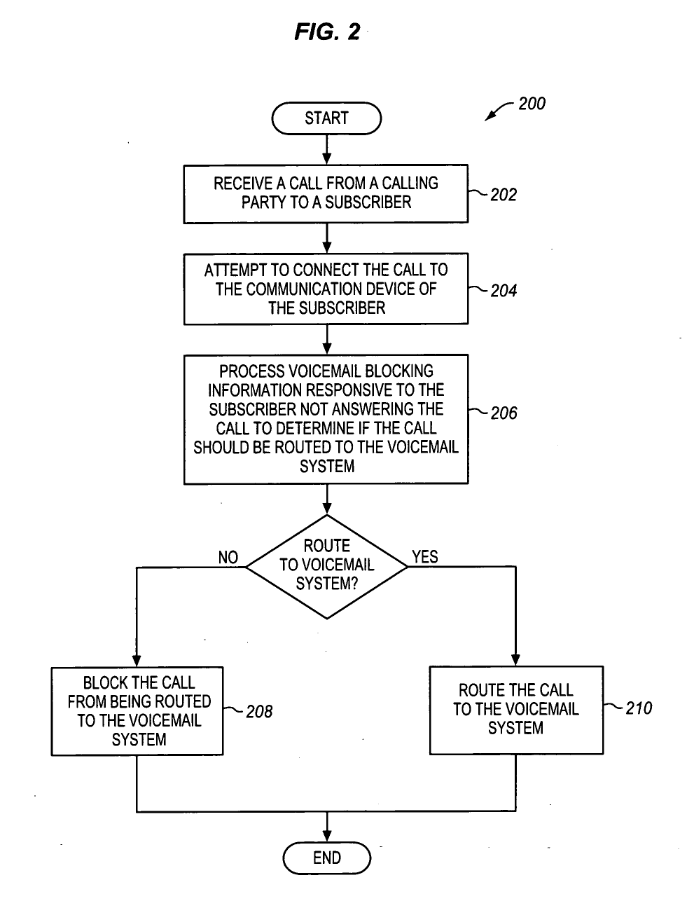

FIG. 2 is a flow chart illustrating an exemplary method 200 of operating communication network 100 to provide the voicemail blocking service in an exemplary embodiment of the invention. The steps of method 200 will be described with reference to communication network 100 in FIG. 1. The steps of the flow chart in FIG. 2 are not all inclusive and may include other steps not shown.

In step 202, network node 102 receives the call from calling party 112 to subscriber 122 which was routed from network node 101. In step 204, network node 102 attempts to connect the call to the communication device 120 of subscriber 122. For instance, network node 102 may provide alerting to communication device 120. Providing alerting may be provided in any desired manner. The assumption at this point is that subscriber 122 does not answer the call responsive to the alerting.

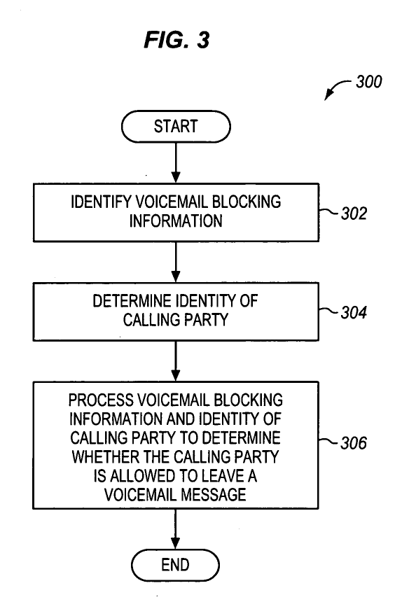

Responsive to network node 102 not being able to connect the call to the communication device 120 of subscriber 122, network node 102 processes the voicemail blocking information to determine whether the call is allowed to be routed to voicemail system 103 in step 206. As previously described, the voicemail blocking information may include a white-list, a black-list, and/or other information used to filter voicemails for subscriber 122. An exemplary method of processing the voicemail blocking information is described in FIG. 3.

If network node 102 determines that the call is not allowed to be routed to voicemail system 103 based on the voicemail blocking information, then network node 102 blocks the call from being routed to voicemail system 103 in step 208. Network node 102 may then release the call responsive to a determination that the call is not allowed to be routed to voicemail system 103. Network node 102 may also transmit a message, such as a text message or a multimedia message, to communication device 120 of subscriber 122 indicating that the call was blocked from voicemail system 103. The message to subscriber 122 may include information on the calling party 112 having the voicemail blocked, such as a name, a directory number, or other information.

If network node 102 determines that the call is allowed to be routed to voicemail system 103 based on the voicemail blocking information, then network node 102 routes the call to voicemail system 103 in step 210. Responsive to receiving the call from network node 102, voicemail system 103 may provide a voicemail service for the call in a conventional manner.

The voicemail blocking service is different than the selective call blocking service presently offered in that communication network 100 attempts to connect the call to subscriber 122 before performing the voicemail blocking. After the attempt to connect the call has failed, network node 102 processes the voicemail blocking information to determine whether calling party 112 is allowed to leave a voicemail message. The voicemail blocking service advantageously allows subscriber 122 to control voicemail blocking separate from call blocking.

FIG. 3 is a flow chart illustrating an exemplary method 300 of processing voicemail blocking information in an exemplary embodiment of the invention. The steps of method 300 will be described with reference to communication network 100 in FIG. 1. The steps of the flow chart in FIG. 3 are not all inclusive and may include other steps not shown.

In step 302, network node 102 identifies voicemail blocking information for subscriber 122. Network node 102 may identify the voicemail blocking information by accessing a local database (not shown) storing the information. Network node 102 may also request the voicemail blocking information from subscriber database 104 if subscriber database 104 is storing the information. In one example, network node 102 may request a subscriber profile for subscriber 122 from subscriber database 104 responsive to the communication device 120 of subscriber 122 registering with communication network 100. The subscriber profile includes the voicemail blocking information along with other information for subscriber 122. In another example, network node 102 may request the subscriber profile from subscriber database 104 before routing calls to voicemail system 103.

In step 304, network node 102 determines an identity of calling party 112. The identity of calling party 112 may include a name of calling party 112, a directory number of calling party 112, a PUID of calling party 112, a network address of calling party 112, etc. Network node 102 may determine the identity of calling party 112 through the calling ID information typically provided in signaling for a call, or may request the information from another database (not shown).

In step 306, network node 102 processes the voicemail blocking information based on the identity of calling party 112 to determine whether the call is allowed to be routed to voicemail system 103 for subscriber 122.

In one example, the voicemail blocking information may include a black-list that identifies one or more parties that subscriber 122 does not want to leave voicemail messages. The black-list may include a list of directory numbers of the unapproved parties, a list of PUIDs, a list of network addresses, etc. Responsive to subscriber 122 not answering a call, network node 102 compares the identity of calling party 112 to the black-list to determine whether or not calling party 112 is on the black-list. If calling party 112 is on the black-list, then network node 102 blocks the call from being routed to the voicemail system 103. If calling party 112 is not on the black-list, then network node 102 may route the call to the voicemail system 103. Network node 102 may also process other voicemail blocking information before routing the call to the voicemail system 103.

In another example, the voicemail blocking information may include a white-list that identifies one or more parties that subscriber 122 does want to leave voicemail messages. The white-list may include a list of directory numbers of the approved parties, a list of PUIDs, a list of network addresses, etc. Responsive to subscriber 122 not answering a call, network node 102 compares the identity of calling party 112 to the white-list to determine whether or not calling party 112 is on the white-list. If calling party 112 is on the white-list, then network node 102 routes the call to the voicemail system 103. If calling party 112 is not on the white-list, then network node 102 may process other voicemail blocking information to determine if the call should be routed to the voicemail system 103.

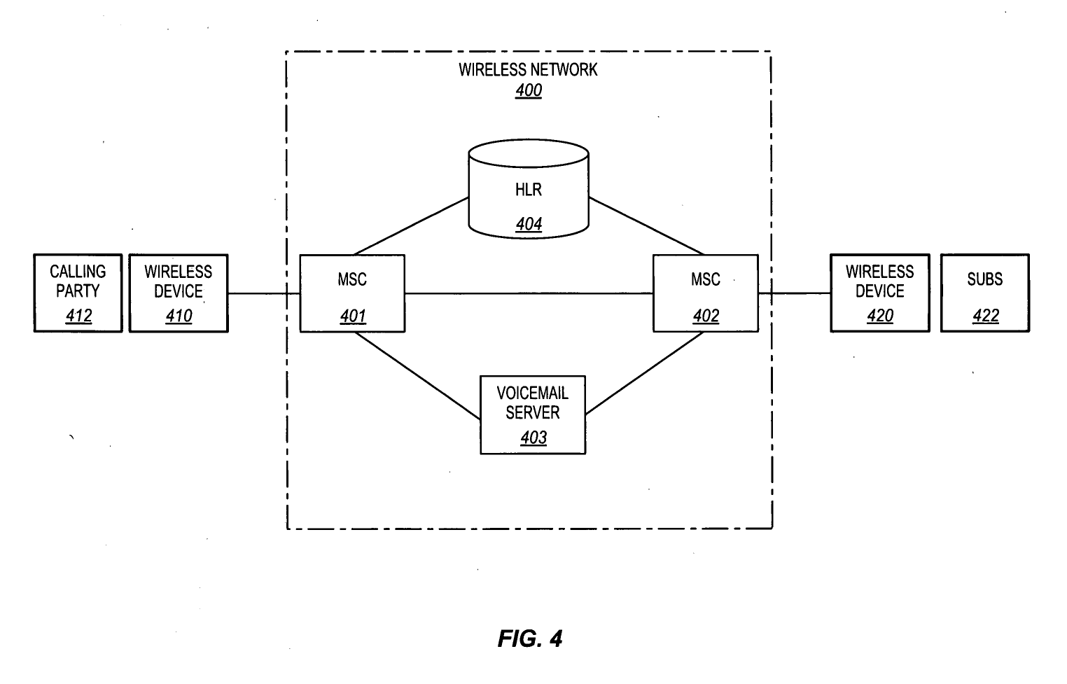

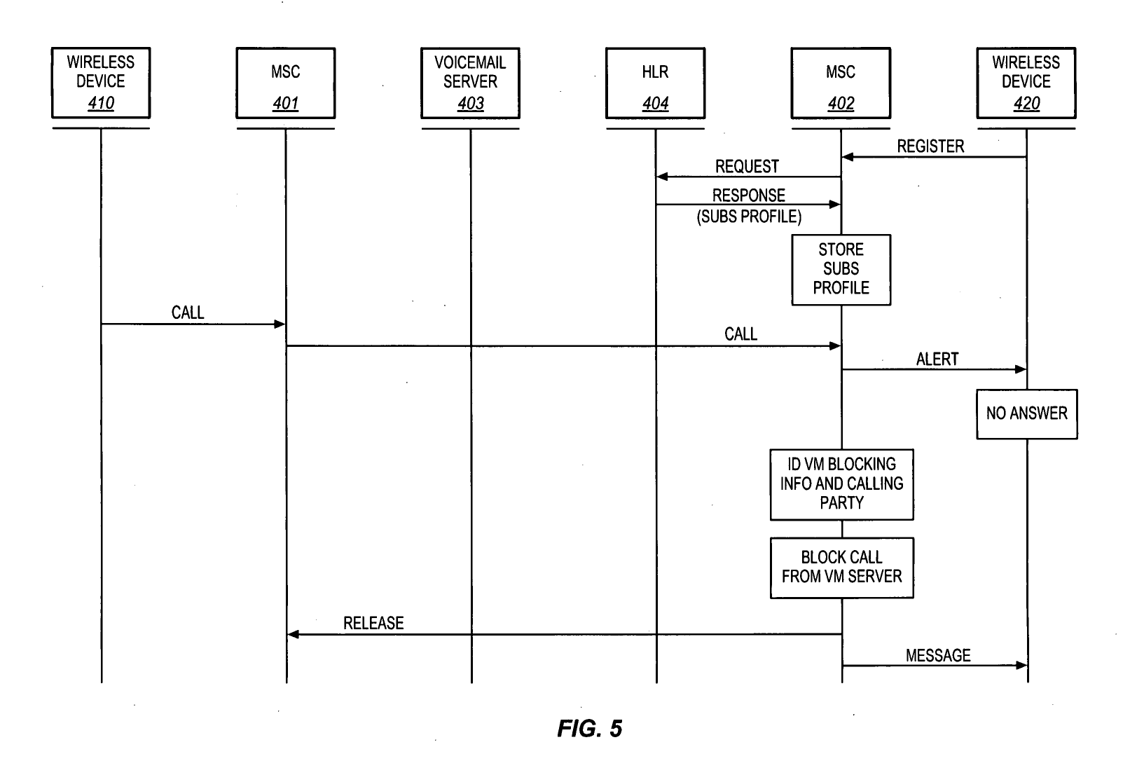

FIGS. 4-5 illustrate an example of implementing the voicemail blocking service in a wireless network in an exemplary embodiment. FIG. 4 illustrates a wireless network 400 in an exemplary embodiment. Wireless network 400 includes Mobile Switching Centers (MSC) 401-402, a voicemail server 403, and a Home Location Register (HLR) 404. In this embodiment, MSC 401 serves a wireless device 410 of a calling party 412, and MSC 402 serves a wireless device 420 of a subscriber 422 to the voicemail blocking service. Those skilled in the art understand that wireless devices 410 and 420 may be served by the same MSC, but two MSCs 401-402 are shown merely for illustrative purposes.

FIG. 5 is a message diagram illustrating the messaging in wireless network 400 to provide the voicemail blocking service. To start, wireless device 420 of subscriber 422 registers with MSC 402. Responsive to the registration, MSC 402 transmits a request message to HLR 404 for the subscriber profile of subscriber 422. As described in the previous embodiment, subscriber 422, the service provider operating wireless network 400, and/or another party has predefined voicemail blocking information for subscriber 422. The voicemail blocking information is stored in the subscriber profile of subscriber 422. The request message from MSC 402 may comprise a MAP UpdateLocation message in a UMTS/GSM network, or may comprise a MAP RegistrationNotification Invoke message in an ANSI41 network.

Responsive to the request from MSC 402, HLR 404 transmits a response message to MSC 402 that includes the subscriber profile for subscriber 422. The response message may comprise a MAP InsertSubscriberData message in a UMTS/GSM network, or may comprise a MAP RegistrationNotification Return Result message in an ANSI41 network. MSC 402 then stores the subscriber profile for subscriber 422 which includes the voicemail blocking information for subscriber 422.

Calling party 412 then places a call to subscriber 422 through wireless device 410. MSC 401 receives the call from wireless device 410, and routes the call to MSC 402. Responsive to receiving the call to subscriber 422, MSC 402 attempts to connect the call to subscriber 422 by providing alerting to the wireless device 420 of subscriber 422. At this point, subscriber 422 is on another call or does not answer the call. Responsive to subscriber 422 not answering the call, the condition for call forwarding to the subscriber's voicemail is satisfied in MSC 402. Before routing the call to voicemail server 403 as is presently done, MSC 402 identifies the voicemail blocking information for subscriber 422 in the subscriber profile. MSC 402 also determines the identity of calling party 412. MSC 402 then processes the voicemail blocking information and the identity of calling party 412 to determine if calling party 412 is allowed to leave voicemail messages for subscriber 422.

If MSC 402 determines that calling party 412 is allowed to leave voicemail messages, then MSC 402 routes the call to voicemail server 403 (not shown in FIG. 5).

If MSC 402 determines that calling party 412 is not allowed to leave voicemail messages for subscriber 422, then MSC 402 releases the call. MSC 402 transmits a release message to MSC 401 and the call is terminated. MSC 402 may also transmit a message, such as a text message or a multimedia message, to wireless device 420 of subscriber 422 indicating that the call was blocked from voicemail server 403. The message to subscriber 422 may include information on the calling party 422 having the voicemail blocked, such as a name, a directory number, or other information.

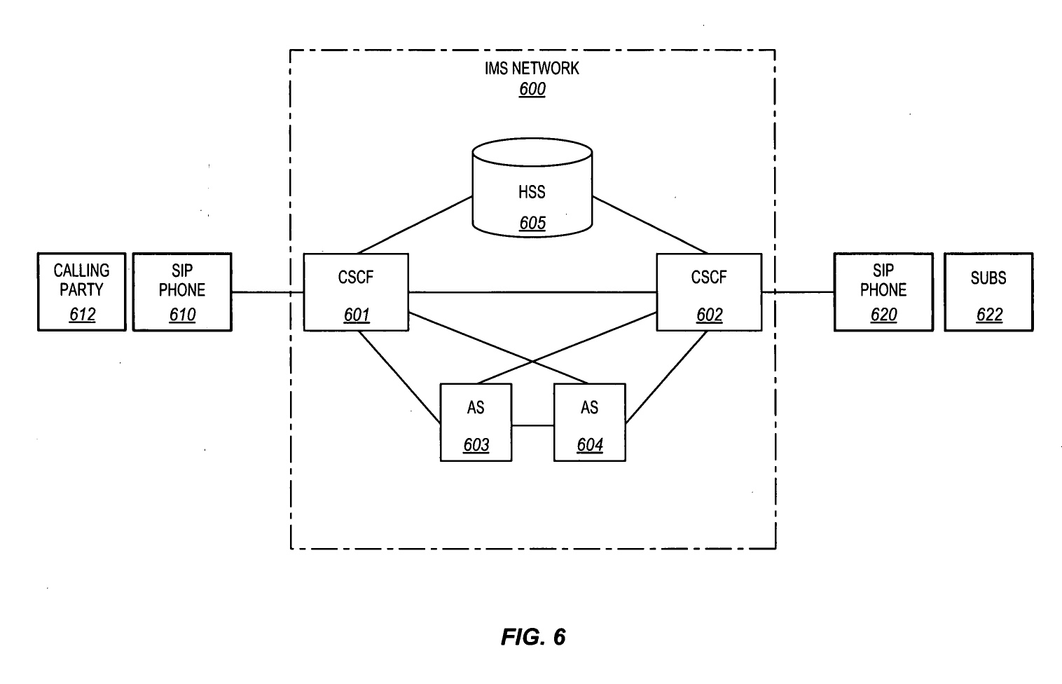

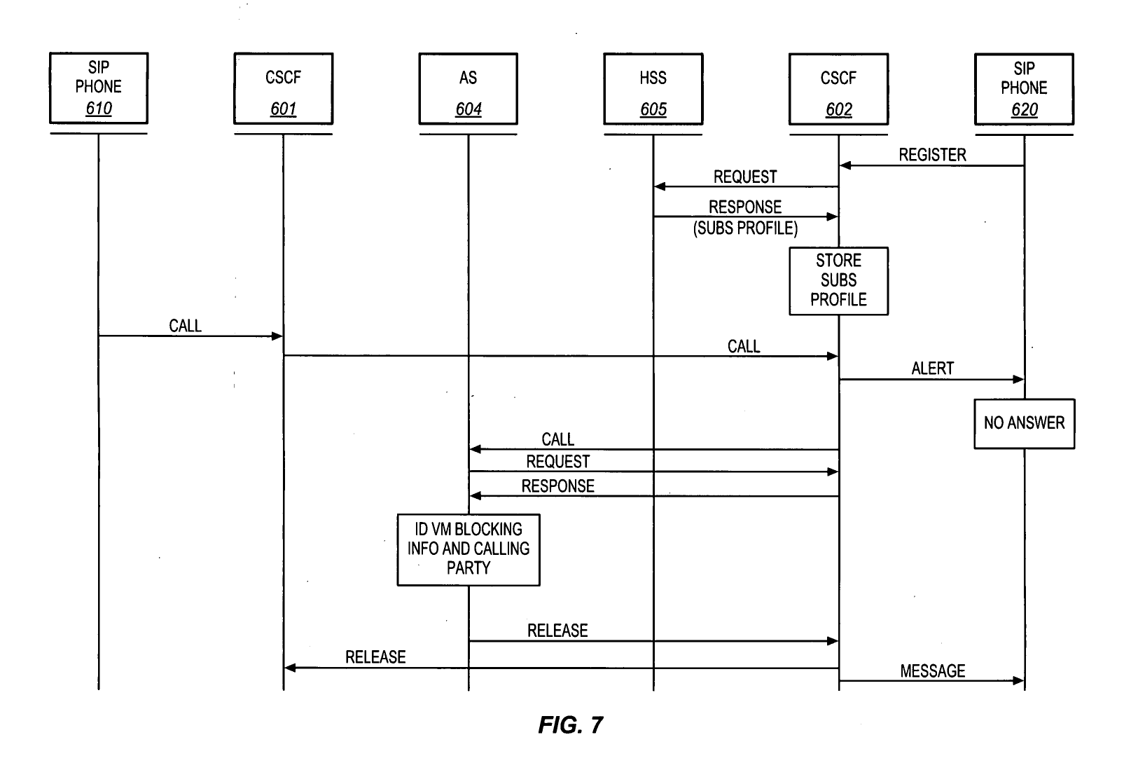

FIGS. 6-7 illustrate an example of implementing the voicemail blocking service in an IMS network in an exemplary embodiment. FIG. 6 illustrates an IMS network 600 in an exemplary embodiment. IMS network 600 includes Call Serving Control Functions (CSCF) 601-602, an Application Server (AS) 603 for providing voicemail services, an AS 604 for providing the voicemail blocking service, and a Home Subscriber Server (HSS) 605. In this embodiment, CSCF 601 serves a SIP phone 610 of a calling party 612, and CSCF 602 serves a SIP phone 620 of a subscriber 622 to the voicemail blocking service.

FIG. 7 is a message diagram illustrating the messaging in IMS network 600 to provide the voicemail blocking service. To start, SIP phone 620 registers with CSCF 602. Responsive to the registration, CSCF 602 transmits a request message to HSS 605 for the subscriber profile of subscriber 622. The voicemail blocking information for subscriber 622 is stored in the subscriber profile of subscriber 622. The request message from CSCF 602 may comprise a Diameter Cx ServerAssignmentRequest message.

Responsive to the request from CSCF 602, HSS 605 transmits a response message to CSCF 602 that includes the subscriber profile for subscriber 622. The response message may comprise a Diameter Cx ServerAssigmentAnswer message. The response message includes the network address for the AS 603 that provides the voicemail service for IMS network 600, and the network address for the AS 604 that provides the voicemail blocking service for IMS network 600. CSCF 602 then stores the subscriber profile for subscriber 622 which includes the voicemail blocking information.

Calling party 612 then places a call to subscriber 622 through SIP phone 610. CSCF 601 receives the call from SIP phone 610, and routes the call to CSCF 602. Responsive to receiving the call to subscriber 622, CSCF 602 attempts to connect the call to subscriber 622 by providing an alerting message to the SIP phone 620 of subscriber 622. At this point, subscriber 622 is on another call or does not answer the call. Responsive to subscriber 622 not answering the call, the condition for call forwarding to the subscriber's voicemail is satisfied in CSCF 602. CSCF 602 then routes the call to AS 604.

AS 604 transmits a request message to CSCF 602 for the voicemail blocking information for subscriber 622. The request message may comprise a Diameter Sh UserDataRequest message. Responsive to the request message, CSCF 602 transmits a response message to AS 604 that includes the voicemail blocking information. The response message may include a Diameter Sh UserDataResponse message.

AS 604 then determines the identity of calling party 612. AS 604 processes the voicemail blocking information and the identity of calling party 612 to determine if calling party 612 is allowed to leave voicemail messages for subscriber 622. If AS 604 determines that calling party 612 is allowed to leave voicemail messages, then AS 604 routes the call to AS 603 that handles voicemail services for IMS network 600 (not shown in FIG. 7).

If AS 604 determines that calling party 612 is not allowed to leave voicemail messages for subscriber 622, then AS 604 instructs CSCF 602 to release the call by transmitting a release message to CSCF 602. CSCF 602 transmits a release message to CSCF 601 and the call is terminated. CSCF 602 may also transmit a message, such as a text message or a multimedia message, to SIP phone 620 of subscriber 622 indicating that the call was blocked from the voicemail service.

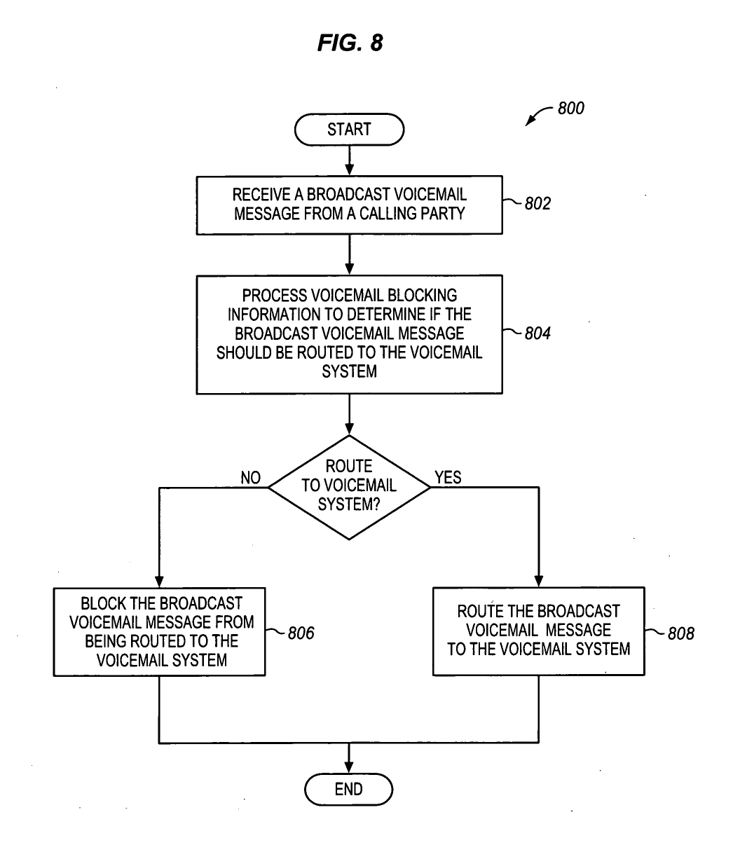

FIG. 8 is a flow chart illustrating another exemplary method 800 of operating communication network 100 to provide the voicemail blocking service in an exemplary embodiment of the invention. In this embodiment, the voicemail blocking service is particularly used to block broadcast voicemail messages. The steps of method 800 will be described with reference to communication network 100 in FIG. 1. The steps of the flow chart in FIG. 8 are not all inclusive and may include other steps not shown.

In step 802, network node 101 receives a broadcast voicemail message transmitted by calling party 112 through communication device 110. The broadcast voicemail message may be intended for subscriber 122 and/or other recipients. Network node 101 may be able to identify that the received message is a broadcast voicemail message based on an identifier in the message.

In step 804, network node 101 processes voicemail blocking information to determine whether the broadcast voicemail message is allowed to be routed to voicemail system 103 for the recipients of the broadcast voicemail messages. The voicemail blocking information may include a white-list, a black-list, and/or other information used to filter broadcast voicemail messages. Although network node 101 is described as processing the voicemail blocking information to provide the voicemail blocking service in this embodiment, other network nodes may provide this function, such as network node 102.

If network node 101 determines that the broadcast voicemail message is not allowed to be routed to voicemail system 103 based on the voicemail blocking information, then network node 101 blocks the broadcast voicemail message from being routed to voicemail system 103 in step 806. Network node 101 may then release the call responsive to a determination that the call is not allowed to be routed to voicemail system 103. Network node 101 may also transmit a message, such as a text message or a multimedia message, to communication device 110 of calling party 112 indicating that the broadcast voicemail message was blocked from voicemail system 103.

If network node 101 determines that the call is allowed to be routed to voicemail system 103 based on the voicemail blocking information, then network node 101 routes the broadcast voicemail message to voicemail system 103 in step 808. Responsive to receiving the broadcast voicemail message from network node 101, voicemail system 103 may provide a voicemail service for the broadcast voicemail message in a conventional manner.

In one example, if the service provider of communication network 100 is aware of entities that are transmitting spam-type broadcast voicemail messages, then the service provider may generate a black-list that includes one or more numbers of the entity transmitting the spam. Responsive to receiving a broadcast voicemail message, network node 101 may determine the identity the calling party 112, and compare the identity of calling party 112 to the black-list to determine if calling party 112 is on the black-list. If calling party 112 is on the black-list, then network node 101 blocks the broadcast voicemail message from being routed to the voicemail system 103. The numbers on the black-list may be supplemented by subscriber 122 or another party.

Similarly in another example, if the service provider is aware of individuals or entities that are transmitting legitimate broadcast voicemail messages, then the service provider may generate a white-list that includes the numbers of the individuals/entities transmitting legitimate messages. Responsive to receiving a broadcast voicemail message, network node 101 may determine the identity the calling party 112, and compare the identity of calling party 112 to the white-list to determine if calling party 112 is on the white-list. If calling party 112 is on the white-list, then network node 101 routes the broadcast voicemail message to the voicemail system 103. The numbers on the white-list may be supplemented by subscriber 122 or another party.

Although specific embodiments were described herein, the scope of the invention is not limited to those specific embodiments. The scope of the invention is defined by the following claims and any equivalents thereof.

We claim:

1. A communication network for providing a voicemail blocking service, the communication network comprising:
a voicemail system; and
a network node serving a communication device of a subscriber to the voicemail blocking service, the network node adapted to:
receive a call from a calling party to the subscriber;
attempt to connect the call to a communication device of the subscriber;
process voicemail blocking information, responsive to a determination that the subscriber does not answer the call, to determine whether the call is allowed to be routed to the voicemail system;
block the call from being routed to the voicemail system responsive to a determination that the call is not allowed to be routed to the voicemail system; and
route the call to the voicemail system responsive to a determination that the call is allowed to be routed to the voicemail system.

2. The communication network of claim 1 wherein the voicemail blocking information includes a white-list of calling parties allowed to leave voicemail messages for the subscriber.

3. The communication network of claim 1 wherein the voicemail blocking information includes a black-list of calling parties not allowed to leave voicemail messages for the subscriber.

4. The communication network of claim 1 wherein the network node is further adapted to:
determine an identity of the calling party; and
process the voicemail blocking information based on the identity of the calling party to determine whether the call is allowed to be routed to the voicemail system.

5. The communication network of claim 4 wherein the identity of the calling party comprises a directory number of the calling party.

6. The communication network of claim 1 wherein the network node is further adapted to:
transmit a message to the communication device of the subscriber indicating that the call has been blocked from being routed to the voicemail system responsive to the call being blocked.

7. The communication network of claim 1 further comprising:
a subscriber database adapted to store the voicemail blocking information;
wherein the network node is further adapted to request the voicemail blocking information from the subscriber database responsive to the communication device of the subscriber registering with the communication network.

8. The communication network of claim 1 wherein the communication network comprises one of a wireless network, a wireline network, or an IMS network.

9. A method of operating a communication network for providing a voicemail blocking service, the method comprising:
receiving a call from a calling party to a subscriber of the voicemail blocking service;
attempting to connect the call to a communication device of the subscriber;
processing voicemail blocking information, responsive to a determination that the subscriber does not answer the call, to determine whether the call is allowed to be routed to a voicemail system for the subscriber;
blocking the call from being routed to the voicemail system responsive to a determination that the call is not allowed to be routed to the voicemail system; and
routing the call to the voicemail system responsive to a determination that the call is allowed to be routed to the voicemail system.

10. The method of claim 9 wherein the voicemail blocking information includes a white-list of calling parties allowed to leave voicemail messages for the subscriber.

11. The method of claim 9 wherein the voicemail blocking information includes a black-list of calling parties not allowed to leave voicemail messages for the subscriber.

12. The method of claim 9 further comprising:
determining an identity of the calling party;
wherein processing the voicemail blocking information further comprises processing the voicemail blocking information based on the identity of the calling party to determine whether the call is allowed to be routed to the voicemail system.

13. The method of claim 12 wherein the identity of the calling party comprises a directory number of the calling party.

14. The method of claim 9 further comprising:
transmitting a message to the communication device of the subscriber indicating that the call has been blocked from being routed to the voicemail system responsive to the call being blocked.

15. The method of claim 9 further comprising:
requesting the voicemail blocking information from a subscriber database responsive to the communication device of the subscriber registering with the communication network.

16. A communication network for providing a voicemail blocking service, the communication network comprising:
a voicemail system; and
a network node adapted to:
receive a broadcast voicemail message from a calling party;
process voicemail blocking information to determine whether the broadcast voicemail message is allowed to be routed to the voicemail system;
block the broadcast voicemail message from being routed to the voicemail system responsive to a determination that the broadcast voicemail message is not allowed to be routed to the voicemail system; and
route the broadcast voicemail message to the voicemail system responsive to a determination that the broadcast voicemail message is allowed to be routed to the voicemail system.

17. The communication network of claim 16 wherein the voicemail blocking information includes a white-list of calling parties allowed to transmit broadcast voicemail messages to the communication network.

18. The communication network of claim 16 wherein the voicemail blocking information includes a black-list of calling parties not allowed to transmit broadcast voicemail messages to the communication network.

19. The communication network of claim 16 wherein the network node if further adapted to:
determine an identity of the calling party; and
process the voicemail blocking information based on the identity of the calling party to determine whether the broadcast voicemail message is allowed to be routed to the voicemail system.

20. The communication network of claim 16 wherein the network node is further adapted to:
transmit a message to a communication device of the calling party indicating that the broadcast voicemail message has been blocked from being routed to the voicemail system.
